(19) United States
(12) Patent Application Publication
(10) Pub. No.: US 2002/0126318 A1
(43) Pub. Date: Sep. 12, 2002

(54) Method for information processing comprising scorecard preparation system for baseball, automatic editing system and motion analysis system

(76) Inventor: Muneomi Katayama, Tokyo (JP)

Correspondence Address: REED SMITH HAZEL & THOMAS LLP, Suite 1400, 3110 Fairview Park Drive, Falls Church, VA, 22042, US

(21) Appl. No.: 09/911,540

(22) Filed: Jul. 25, 2001

(30) Foreign Application Priority Data
Dec. 28, 2000 (JP) 2000-404708

(51) Int. Cl. H04N 1/21; H04N 1/00

(52) U.S. Cl. 358/402; 358/302

(57) ABSTRACT

The present invention comprises a scorecard preparation system, an image system, an automatic editing system and a motion analysis system wherein the scorecard preparation system body comprises an input terminal, such as a mobile terminal, the step of forwarding the data by inputting the movements of players and other information in a chronological manner by means of the input terminal, the step of forwarding the data, a data recording medium such as a tape, an FD or a data server which incorporates real time data forwarded by utilizing a network, a plurality pieces of image information, such as a bird's eye view image or a zoom image of the above players, the step of encoding and forwarding them and an image recording medium such as a VCR, a DVD or an image server, which contain the above described digitalized image data, and the screen of the above described data input terminal, by means of which the user (audience) can access, through the Internet, either the above described data medium or image medium, or both of them, and can link together a predetermined image and the data so as to be outputted on the same screen of an output terminal, such as a mobile body like a cellular telephone, or a personal computer, comprises an input part of the pitcher motion, an input part of the batter motion and an other information part.

The above and other necessary data are inputted as information resources, while taking the information processing function, or the like, of the personal computer into consideration, and are then processed and edited so that the output thereof is instantly displayed on the display of the computer as letters, graphics or graphs or as one piece, or a plurality of pieces, of image information.

### DETAILED DESCRIPTION OF THE INVENTION

1. Field of Industrial Application

This invention relates to a method for information processing comprising a scorecard preparation system for baseball, an automatic editing system and a motion analysis system, for recording a variety of data of baseball games which are actually played, such as of a professional baseball league, for processing them so as to be reproduced as a representation in letters, a graphic representation or as still or moving image information and for learning by a player, or teaching by an instructor, such as a coach, a correct pitching form or batting form.

b 2. Problem to be Solved by the Invention

Conventionally, in a baseball game, the entire data of the progress of the game are, in general, manually recorded on a sheet of paper for data recording, called a “scorebook,” by a recording specialist who is called a scorer. And, for example, the reason why a pitcher gave up a homerun or the reason why a batter struck out are desired to be known. This sheet of paper is used to discover the reasons for the above events so that appropriate measures can be developed. In order to perform such an analysis and to gain a result, however, a specialist, such as a person who is called a scorer, must be relied upon and when a desired event must be selected the precision is poor, despite the considerable amount of time spent therein.

That is to say, for example, if a pitcher could know the type of pitch and the position of the ball when he gave up a “homerun” to a batter, the pitcher could use this knowledge to his, great, advantage the next time that he faced the same batter. On the contrary, in the case that a batter is struck out by a pitcher, if the batter could know the type of pitch or the position of the ball when he struck out and, in addition, if he could see the form of the pitcher as a still image or as a moving image, the batter could gain a great advantage over the pitcher the next time that he faced the same pitcher. Though the above is true, it is almost impossible for a conventional means to be utilized for such an analysis in order to gain such a result.

In addition, as for this category of invention utilizing a VCR or other electronic device, an invention wherein an exemplary performance, or the like, are inputted, in advance, as a video image or as a DVD image and those images are overlapped with the performance, or the like, by a learner through an operation so that guidance can be given through a three dimensional image is published as U.S. Pat. No. 5,184,259 (issued on Feb. 2, 1993).

According to the above patent, however, since an excellent exemplary performance, or the like, is used for the video or DVD image, an effective guidance for a particular learner taking the learner's age and physical strength into consideration or a step-by-step guidance method prepared for each learner cannot be given.

Therefore, the performance of a learner, or the like, is video taped as an image and one screen of the image is reproduced on a display while the range of the motion to which attention should be paid or the basic body outlines which form an optimal position, or the like, are shown with a line, or the like, overlapping the image of the learner's performance on the screen. An application containing this idea was filed by the inventor of this application prior to this invention, which has already been filed in the U.S. as application Ser. No. 07/854,093 on Mar. 19, 1992 and was granted U.S. Pat. No. 5,333,061. And this invention, gained by improving hereupon, is particularly adapted to baseball wherein a large amount of data is used.

That is to say, the main purpose thereof is to instantly perform processing of a variety of data, approaching infinity, concerning baseball so that a desired analysis of a specific condition can be fed back by simultaneously displaying data and image, based on the above data, to a player, a coach or an instructor as a point for subsequent practice by the player.

In general, the purpose of the present invention is, taking the information process performance of a personal computer, or the like, into consideration, to input the above and other necessary data, which are then processed and edited resulting in the output thereof as letters, graphics or graphs, as an information resource and, in addition, to instantly display the results on the display of the computer as one, or a plurality of, pieces of image information.

### MEANS FOR SOLVING THE PROBLEM

This invention is characterized by being configured of the three systems described below, that is to say:

(1) “scorecard preparation system”

This system is a system which inputs scoring, which is a task carried out by a so-called scorer, by utilizing a keyboard or a touch board of a computer without paper. In addition, this system is characterized in that a variety of information, such as the type of pitch of each thrown ball and the result of the thrown ball (ball, strike, foul, single, double, triple, homerun) can be individually inputted according to respective conditions. And this system includes a recording of images through the use of a video camera or a digital camera, including the use of a digital video camera for taking images from the start of the game and throughout the entire progression of the game.

(2) “automatic editing system”

This system utilizes data stored in the above described scorecard preparation system and a video camera or a digital camera, including a digital video camera, and comprises the above described continuously recorded tape as well as a system for automatically editing images from the image data. Here, this invention is characterized by having a system which automatically selects and edits necessary and desired conditions from among the data in the above described scorecard preparation system as an image which agrees with those conditions.

For example, the system concretely makes possible the editing of the event where, specifically, a particular batter swings the bat at a fastball, the editing of the event where, specifically, a hit is made in relation to the above event, or the editing of the event where a particular pitcher throws a fastball, specifically.

(3) “motion analysis system”

This system utilizes the two systems described above and is characterized in that, for example, the data and the image under the above described specific conditions can be displayed in split screens of right and left, or above and below, in the layout of a computer and, in addition, the ratio of the screen can be made 5 to 5 or 7 to 3, in that respective screens can be scrolled individually or can be scrolled together at the same time and in that it is possible to draw lines, letters and graphics on these screens so that these letters or graphics can be stored in the computer or erased from the computer. Accordingly, the coach can utilize this system as a “terminal” to explain his or her theory using the displayed image of this player, and the player himself or herself can operate the system to select the image to be used as reference material for correcting his or her own form.

The “scorecard preparation system” of the present invention is concretely characterized in that the input screen of the above described personal computer comprises an input part of pitcher motions, an input part of batter motions and other information parts where the input part of pitcher motions has, at least, input keys for the starting time and the finishing time of the game, input keys for the names of pitchers and for the names of the corresponding batters for the game, input keys for the types of pitches thrown by the pitchers, such as curve, screwball, slider, input keys for figures from 0 to 9 and has graphics of the strike zone arranged in proper positions, and wherein the input part of batter motions has the graphics of the diamond that shows in predetermined positions, at least, all of the names or numbers of the members of the defensive team and batter and input keys for strike out, hit ball resulting in an out, single, double, triple, homerun arranged in proper positions, as well as wherein the other information parts have a display of respective team names, a display of graphics of the scoreboard and a display of the ball, strike and out count arranged in proper positions.

Then, at the same time as a desired game starts, the input key for the above described starting time is clicked and, simultaneously, the video camera or the digital camera, including the above described digital video camera, is driven in a synchronous manner. And, after that, as the game progresses, first, the type of pitch of a ball thrown by a pitcher is judged so that the input key for type of pitch of the above described pitcher motion input part is clicked and the position which agrees with the position of the ball thrown by the pitcher is clicked on the graphics of the above described strike zone and, thereby, the pitch type and the position are represented by letters or graphics on the graphics of the strike zone. Through the above described simple operation, the below described data of important information concerning this pitcher can be gained.

In addition, in the case that a batter gets a hit, the position to which the ball goes is judged on the graphics of the above described diamond and the position is clicked on the graphics of the diamond. Through this simple operation a line is drawn between that position and home base and a scorecard preparation system is formed wherein all of the motions of the batter throughout the game or a desired inning number or the data of the entire game can be stored in a personal computer, on a video tape or on a DVD for later reproduction on the monitor.

Concretely speaking, the present invention is characterized in that balls and strikes are automatically counted by keys, by clicking the input keys for balls and strikes so as to be displayed on the display for the above described ball, strike and out count.

Concretely speaking, the present invention is characterized in that when three outs are made “O” is automatically displayed in a predetermined place of the graphics of the above described scoreboard, in that by clicking the input keys for single, double, triple or homerun, the name or the number of the batter is displayed in a predetermined position which is close to a base on the graphics of the diamond and in that whenever the runner reaches home base, the score is automatically displayed in a predetermined position of the graphics of the above described scoreboard.

Concretely speaking, an “automatic editing system” of the present invention is characterized by comprising the above described scorecard preparation system, a personal computer which processes, stores and controls the data inputted to this system, an input terminal such as a touch pen for inputting information or conditions in this personal computer, a monitor display, one, or a plurality of, video cassette recorders or DVD recorders connected to the above described personal computer via a converter which carries out image processing on a signal from the personal computer, one, or a plurality of, controllers which is incorporated in the video cassette recorders or DVD recorders and which display desired images on the above described monitor display as a still image or as a moving image, an automatic image editing system which is connected to the personal computer and which comprises the video cassette or the DVD edited by the above described controller, edited images outputted to the personal computer of this system, a personal computer which has a monitor display and which processes the input data, a converter connected to this personal computer, a motion analysis system formed of a video deck for reproduction, or a DVD deck for reproduction, connected to this converter through a dedicated cable and a video deck for recording, or a DVD deck for recording, connected through a rank cable, and a condition setting screen outputted to the personal computer of this motion analysis system.

Then, the editing screen has input keys for the names or the numbers of the players, at least, who have appeared in the game, or of all of the members, input keys for the names or numbers of the batters who have batted in the game or of all of the members, input keys for types of pitches thrown by pitchers, such as curve, screwball, slider, and input keys for time adjustment of the image output arranged in appropriate positions and the condition setting screen has input keys for pitcher, batter or others who have been selected and conditions set therefore, input keys for setting the innings or the number of the innings, the top of the inning and the bottom of the inning, input keys for the names of pitchers and the names of batters who face the pitcher during the game, input keys for type of pitch thrown by a pitcher, such as curve, screwball or slider, and input keys for displaying images, graphics and tables deposited in appropriate places and, thereby, a variety of analysis screens of the below described motion analysis system can be easily displayed and in a manner that the analysis result becomes clear.

Concretely speaking, the first analysis screen displayed on the personal computer of the present invention is characterized in that input keys for, at least, the display screen of the players, graphics of the strike zone, graphics of the diamond, image display, graph display, condition display are arranged in appropriate positions on this first analysis screen.

Then, positions and types of pitch by a particular pitcher at the time when the pitcher pitched to a particular batter can be extracted from the data stored in the personal computer so as to be automatically displayed as letters or graphics on the graphics of the strike zone. Accordingly, the most desired information, from the viewpoint of the pitcher, concerning the batter such as weakness to inside and low pitches, strength with outside and high pitches, weakness to forkballs or strength with fastballs can be instantly given.

In the case that the batter accesses this screen, he can know the so-called pitcher's habits concerning his pitching so that types of pitch or the positions of balls for the next pitch can be predicted.

In addition, a line is automatically drawn between the position to which the ball, hit by the batter, goes and home base on the graphics of the diamond. Therefore, the pitcher can gain useful information, for the times in the future that the pitcher faces the same batter, such as which position or which type of pitch could be hit for a single, a longer hit or fouled off.

In addition, by clicking image displays within the input keys for image displays, graphic displays or table displays, images of the events of the times that the same pitcher and same batter face each other from the video, or the DVD deck, for reproduction which synchronizes with the personal computer so that a part of, or the entirety of, the above described first analysis screen can display a still image, an intermittently moving image, or a moving image and, thereby, the pitcher can read the “habits” of the swing of the batter in order to achieve effective pitching to this batter in the future. On the other hand, the batter can gain an advantage over the pitcher when he reads the “habits” of the pitcher from his pitching form, such as the pitching motion when throwing a “fastball” or the pitching motion when throwing a “slider.”

Concretely speaking, the second analysis screen displayed on the personal computer of the present invention is characterized in that the editing screen of the personal computer and the condition setting screen can be gained wherein a particular batter can be selected and gained by clicking the input key of this condition setting screen so that, for example, the user can be compared side by side with another excellent pitcher or excellent batter so as to find the user's own weakness to be corrected. This second analysis screen is approximately the same as the above described first analysis screen.

Concretely speaking, the third analysis screen displayed on the personal computer of the present invention is characterized in that, by clicking the input key for the event of a particular pitcher and a particular batter facing each other in the above described motion analysis system and by clicking a key for a graph display in the input key for the condition display, the personal computer displays the third analysis screen which has, at least, the graphics of the strike zone, the number of each of twelve types of pitches resulting in balls or strikes, graphics such as pie charts or bar graphs and input keys for image display arranged in appropriate positions.

Then, for example, a particular pitcher is selected and the total number of pitches thrown by this pitcher and, for example, the number of “sinker” pitches are compared by automatically displaying the ratio thereof displayed in graphics, such as a pie chart or a bar graph which may include a variety of colors and, thereby, the types of pitches that the particular pitcher is good at, or is poor at, can be known.

Here, it also becomes possible to ascertain the pitching form according to the types of pitches thrown by the pitcher by selecting the image of the pitcher for the game which is displayed as a still image, an intermittently moving image or a moving image on a part of, or the entirety of, the above described analysis screen. In addition, by carrying out a similar operation to this for a batter, information desired to be known concerning the particular batter can, of course, be gained.

Concretely speaking, the fourth analysis screen displayed on the personal computer of the present invention is characterized in that the above described condition setting screen is provided with a speed output key.

Then, by clicking this speed output key, the speed and the number of pitches thrown by a particular pitcher are analyzed resulting in information for a batter which can be used for form correction at the time of addressing the pitcher, or at the time of ball to bat contact.

Here, the present invention is also characterized in that, at the time of carrying out the invention, the user, a coach or a coordinator can freely draw letters or graphics for guidance with an input terminal, such as the touch pen of this system, on the display shown in each of the analysis screens and the image, after the drawing is completed, can be recorded again on the tape so as to be viewed on the monitor.

Concretely speaking, the fifth analysis screen displayed on the personal computer of the present invention is characterized in that an output key for the events when facing a particular team is provided on this screen and by clicking this output key for the events when facing that particular team, the name of a specific batter and a table are displayed, all of the names of the pitchers who have faced this batter are displayed along the Y axis of this table, the number of times at bat, at least, the number of hits, the number of homeruns, the number of walks and times hit by the pitch, the number of strike outs, batting average and batting average with runners in scoring position are displayed along the X axis of the above table, the resultant number from each item and the calculation result counted or calculated from the data stored in the personal computer, plotted at the intersection points between that Y axis and X axis, can be displayed.

In addition, a table of right handed pitchers facing a batter and a table of left handed pitchers facing the same batter can be provided on the above described screen and, as a result, it becomes possible to find out weather this pitcher is vulnerable to left handed batters or to right handed batters.

In this invention, the expression of “baseball” is not limited to baseball as presently played in a variety of countries but, rather, includes so-called kickball, softball and practice for these games.

In this invention, “analysis screen” is not limited to analysis of embodiments illustrated above but, rather, includes all of the representations by letters, graphics and images gained by editing, or processing, inputted data and “the first analysis screen, the second analysis screen and so forth” are utilized only for the purpose of convenience in order to describe the present invention and do not show the order of the analysis.

Here, this invention has other excellent analytic methods, means or effects, which are clarified in the following embodiments.

Though the devices utilized for the scorecard preparation system, the automatic editing system and the motion analysis system are described as, respectively, different devices in order to describe the technical contents of this invention, they may essentially be a shared device and, therefore, common symbols are used in the embodiments described below.

In general, the automatic search system of the present invention comprises a plurality of pieces of image information, such as bird's eye view images, zoomed in images, and the like, of the players in the game the step of encoding them so as to be forwarded, an image server in which the above described digitalized image data are built in, by utilizing a network, the step of inputting the motion of the players, other speech sound information, or the like, in a chronological manner so that the data thereof are forwarded and a data server in which the real time data forwarded by utilizing the network are built in.

Then, the user (audience) accesses either the above described image server or data server, or both, through the Internet and, thereby, the image data and the real time data can be linked on the screen so that the desired images and the related real time data can be seen at any time desired.

Here, as for the network, not only the conventional Internet but also the “i-mode” system of a mobile unit, such as is used in recent cellular telephones, can, of course, be utilized.

### Embodiment 1

In the following, the present invention is described in reference to the illustrated embodiment and in FIG. 1 a baseball stadium is denoted as (1), a plurality of cameras for a bird's eye view image (3), a zoomed in wide image (4), and the like, are denoted as (2), which are connected to an encoder (5) that has a time compression function, a multiplication function and a packet transmission function including a digital disc recorder, a still image filing device, a frame synchronizer, and the like. In addition, an image server, which is connected thereto via an Internet line (9), is denoted as (6).

As for the above described cameras (2), a plurality of cameras (2) are prepared for securing a bird's eye view image (3) in order to capture the movement or the condition of each player, or the like, in a realistic manner at the time when a sport program is broadcast by relay or in order to capture a zoomed in wide image (4) of every move made by famous players.

In addition, two terminals for inputting data concerning every move made by players which are used to make up for a so-called input miss and to increase precision, which are denoted as (7) in the figure, are prepared herein.

Moreover, a data server, wherein the data sent from the above described input terminals (7) via a data forwarding device (10) and a network can be built in and, at the same time, additional data (contents), including profiles of respective players, can be built in if necessary, is denoted as (8).

Furthermore, this data server (8) has a data base server program which has a master maintenance function, a master update function at the terminal end, a data search function and a data forwarding function of the search result as well as a data converting program which has an input data real time display data converting function, an input data file transmission/reception function, a data base update function and a master update file terminal forwarding function.

In addition, as for the above described time compression function, a protocol called MPEG2 (moving picture experts group 2) already exits and, therefore, time compression of information is carried out by using these characteristics and the above described data information can be incorporated in the relay information by combining links between time and images, links between time and data, or the like.

That is to say, in the above described MPEG2, the frames are not decoded in order of reception and, as for the frames which have been time compressed, there an I frame, a P frame, and a B frame which is expected to be made of these I and P frames.

For example, the frames received in the order of IBBP are decoded in the order of IPPB wherein said P frame is first calculated and, then, said two B frames are calculated by utilizing said I frame and, next, a new I frame is used to make up two B frames.

By applying the above described processing technology of frames, that is to say, by processing two essential data stream formats by means of software, a multiple bucket transmission can be carried out and by transmitting data to the user (audience) in TS (transform stream) packets after text data with closed captions are built in, said user (audience) can select data as he or she likes.

That is to say, a stationary output terminal, such as a personal computer of the user, which is connected to the Internet so that information recorded or stored in the image server (6) and in the data server (8) can be searched, is denoted as (A) in FIG. 1. Recently, it has become possible for information of the image server (6) and of the data server (8) to be directly read out via the Internet (9) by means of the “i-mode,” or the like, through the usage of mobile output terminals (B), such as a cellular telephone.

Then, the above described input terminal (7) is brought to the baseball stadium (1).

In this case it is important to also bring the above camera (2) and, in the case that this game is broadcast on TV, it may be recorded or information from the screen of this TV broadcast may be inputted into the above described input terminal (7). According to this invention, however, a precise determination of the quality of the pitches by the pitcher, such as fastball, curve, slider, screwball or forkball, or detailed data concerning batters are required and, therefore, it is important to visit the stadium in person.

When carrying out the present invention, these apparatuses do not need to be utilized but, rather, apparatuses available in any household can, of course, be utilized.

That is to say, an input terminal (12), such as a keyboard with a touch pen (11) and a personal computer (13) into which information from the terminal (12) is inputted are shown as examples of the above in FIG. 2.

A video tape driven in sync with the personal computer (13), or a video camera of a digital system or digital camera (16) which can monitor the game using the DVD (15), is included in (15), and is connected, for image information, to the personal computer (13) via a converter (17).

In addition, a video camera of a digital system or a digital camera (16) as well as a video tape or DVD (15), which is incorporated therein, converts a signal from the above described personal computer (13) into an image signal and, therefore, they are connected to the above described personal computer (13) via the converter (17) as described above. In this case, it is preferable to provide a plural number of cameras (16) in positions wherein images from behind the back net (behind the catcher) and images of the entire field can be captured. In addition, it is preferable to install cameras so as to gain bird's eye view images or close up images.

In addition, a VCR, a writable DVD or an FD for storing information edited by the personal computer (13) is denoted as (18) in the figure and a printer for outputting as a hard copy images or characters displayed on the display of the personal computer (13) is denoted as (19).

Now, the input operation of data, that is to say, an input means of the scorecard preparation system is described in reference to FIG. 1 when the input terminal (7) is actually brought to a baseball stadium where a baseball game is played. Here, it is also possible to first record the actually played baseball game by means of a VCR and to input data while watching the reproduction of the game shown by means of this VCR.

Now, the above described input terminal (7) is started up at the same time that the start of the game is announced, so that an input screen (20), as shown in FIG. 3, is displayed on the display of this input terminal (7). And, at the same time, the camera (2) is turned on to start the capturing of images. This is important because the time of an event should be stored for the adopted system where the data and/or images of a certain section are called up based on this time in the case, for example, that a batter's form for a homerun hit in a certain inning is desired to be seen for later analysis using the motion analysis system.

Accordingly, this input screen (20) comprises an input part (21) for pitcher motion, an input part (22) for batting and fielding motions and an other information part (23).

The above described input part (21) for pitcher motion is provided with, at least, input keys (24) for the starting time and the finishing time of the game, input keys for pitcher names (25) and names of batters' facing those respective pitchers (26), input keys (27) for types of pitches thrown by respective pitchers, such as curve, screwball or slider, input keys (28) for figures from 0 to 9 and graphics of the strike zone (29).

In the input part (22) for batting and fielding motion graphics (31) of, at least, the diamond wherein the names or numbers (30) of all of the fielders and batters are shown in predetermined positions and input keys (32) for strike out, hit ball resulting in an out, single, double, triple and homerun are arranged in appropriate locations.

In the other information part (23), representation (33) of the names of the respective teams involved in the game, a graphic (34) of a scoreboard, representation (35) of the ball, strike and out count are arranged in appropriate locations and, in addition, it is important to provide keys such as “return ball to pitcher,” “memo” or “redo input.”

Here, it is assumed that the pitcher throws the first pitch. First, the type of the pitch thrown by this pitcher is determined and the input key (27) for the type of pitch in the above described input part (21) for pitcher motion is clicked and, at the same time, the location on the above described graphics (29) of the strike zone which agrees with the position of the pitch thrown by the pitcher is clicked so that the type and the position of the pitch are represented on the graphics of the strike zone as letters or graphics (36).

In this FIG. 3, the condition where the pitcher threw a pitch in the center of the graphic (29) of the strike zone is shown. Subsequently, in the case that the type of pitch is “fastball,” the selected representation of the input key (27) for that type of pitch is clicked.

At this time, the batter is assumed to “hit” this pitch. In this case, the position on the above described graphics (31) of the diamond to which the ball is hit is determined and, by clicking the position on the graphics (31) of the diamond, a line (37) is automatically drawn between that position and home base, as shown in FIG. 4.

In addition, the name or number of the batter is represented in the vicinity of home base (38) in a predetermined position of the graphics (31) of the diamond.

Here, as for the pitcher name or the name of the batter facing that pitcher, the names of the players are, for example, stored in advance so as to correspond to the “numbers” of those players and, when those numbers are inputted with the input keys “28” for the figures from 0 to 9, the names of those players are represented.

In addition, in the case that the batter lets a strike pitch go by, by clicking the input keys (35) for ball, strike or out, the count of balls and strikes is automatically carried out so that the above described count of ball, strike and out is represented.

In addition, when three outs are made without any runs scoring, “O” is automatically represented at a predetermined location of the above described graphics (34) of the scoreboard while whenever a runner reaches home base the cumulative score is represented in a predetermined location of the above described graphics (34) of the scoreboard.

In the actual baseball stadium, the above described operations are carried out for every movement, and subsequent resulting movements, made by pitchers and batters until the completion of the game or until the necessary numbers of inputs for a variety of types of data are completed.

Then, the data gained in this manner are stored in the data server via the data forwarding device (10) and the Internet (9).

At the same time as this, image data captured by the cameras (2) are stored in the video server (6) via the encoder (5) and the Internet (9).

Next, the output is described. Here, in the case that a member of the audience outputs the above described data information or image data, a stationary output terminal (A), such as his or her own personal computer, or a mobile output terminal (B), such as a cellular telephone, is started so that an output setting main menu (C) is displayed as shown in FIG. 6.

Thereby, the input keys (39) for pitcher (86), batter (87) or catcher (88), the input keys (40) for deciding whether or not to set the inning or for the inning, the top of the inning or the bottom of the inning, the input keys (43) for pitcher name (41) of the game, name of batter facing that pitcher (42) and types of pitches thrown by the pitcher, such as curve, screwball or slider, and the input keys for image display (44), image setting display (45) and graph representation (46) are first arranged and represented in appropriate locations and, then, the member of the audience clicks a desired location for the information he or she desires to know.

### First Embodiment of Analysis Screen

Now, an input key for the face-off between a left-handed pitcher, for example Hanshin's “Nobuyuki Hoshino,” (81) and a left-handed batter, for example Yomiuri's “Hideki Matsui,” (82) is selected from the above described output setting main menu (C) and is clicked and, then, the indication is sent from the above described output terminal (A) or from the mobile output terminal (B) to the data server (8) via the Internet (9) so that those conditions are searched for within this server (8) and the program of the editing system allows the graphics as the first analysis screen (47), as shown in FIG. 7, to be represented on the above described output terminal (A) or mobile output terminal (B).

That is to say, in this first analysis screen (47), input keys for, at least, display screen (48) of the players facing each other, the graphics (49) of the strike zone, the graphics (50) of the diamond, the image display, the graph representation and the representation of conditions are arranged in appropriate locations.

The description continues by citing concrete examples. Batting coaches or pitching coaches request analysis as shown in FIG. 7. For example, judging from FIG. 7, Yomiuri's left-handed batter Hideki Matsui appears to have difficulty in dealing with Hanshin's right-handed pitcher Keiichi Yabu.

Then, those two are clicked in accordance with the above described search conditions so that the types and the positions of pitches thrown by the pitcher to the batter are automatically edited and outputted on the graphics (49) of the strike zone by searching the data stored in the data server (8).

At this time, as a scene on the graphics (49) of the strike zone, the types of pitches may be represented with symbols or with colors, such that a fastball if denoted as “◯,” a screwball is denoted as “●,” a forkball is denoted as “▪,” a sinker is denoted as “▴” and a slider is denoted as “Δ.”

Accordingly, valuable information resulting from analysis is gained from this screen, such as that this pitcher “has good control and throws many inside pitches” or “though fastballs have a high probability of being strikes, sinkers have a high probability of being balls and, therefore, it is better to let sinkers pass by.” Thereby, guidance can be gained regarding how to determine which pitches can be hit.

Furthermore, in the case that the batter who is receiving guidance views this screen (in particular, a screen is outputted showing chronological progress, rather than as a still screen), he learns the pitcher's “habits” concerning the types, or so-called combinations, of pitches thrown by the pitcher (or, it may be said, the habits of the catcher who directs this pitcher's combination of pitches) so that he can predict the type or the position of the pitch that will be thrown the next time.

In addition, a line is automatically drawn on the graphics (50) of the diamond between the position to which the ball, hit by the batter, has been hit to and home base. This is in order to gain useful information for the subsequent meeting such as which position or which type of pitch, by the pitcher, that will enable the batter to hit a single, a long hit or that will cause the batter to hit a foul ball.

In addition, by viewing the graphics (49) of the strike zone and the graphics (50) of the diamond, desired information can be instantly given such as that a certain batter is poor at hitting low and inside pitches or is good at hitting high and outside pitches with a high probability of hitting a long hit while the batter hits forkballs resulting in outs but successfully hits fastballs.

Furthermore, by clicking the image display key on the display where the input keys (51) for image display, graph representation and table representation are shown, the image of the match up between a pitcher and a batter is extracted from the image server (6), which synchronizes with the related data display, so as to be shown (52) as a still image, an intermittently moving image or a moving image on a part of, or on the entirety of, the above described first analysis screen (47) as shown in FIG. 8.

Thereby, the pitcher can, for example, read out the “habits” of the batter's swing so that he can throw effective pitches to this batter based on that and, on the other hand, the batter can read out the “habits” of the pitching form of the pitcher, such as the form when “fastballs” will be pitched or the form when sliders will be pitched, so that the batter can gain an advantage over the pitcher.

In addition, for example, a coach who has carried out the analysis as shown in FIG. 9 can show a “vertical line” (54) with the touch pen, as shown in FIG. 10, concerning the analysis that this pitcher “throws fastballs when the position of his head and the position of his feet are in alignment” or can give a letter representation (53) such as the description of the “point” as shown in FIG. 10 concerning the position regarding the pitching motion of the pitcher by making the analysis that “when the ball is held at the position of the belt, he will throw a sinker,” so that a batter can, thus, gain valuable information. Here, this letter representation (53) can, of course, be stored as it is.

### Second Embodiment of Analysis Screen

The second analysis screen shown in FIG. 11, denoted as (55), shows wherein two specific batters can be selected so as to be compared with each other.

That is to say, in this second analysis screen (55), the graphics (56), (57) of strike zones for, at least, the two batters being compared, the graph (58) of the diamond and input keys (59) for image display, graph representation and condition representation are arranged in appropriate locations.

In addition, in the graphics (56), (57) of the strike zones, the positions and the types of pitches thrown to the two batters by a certain pitcher are extracted from the data stored in the data server (8) so as to be automatically represented in letters or graphics (60) while lines (61) are automatically drawn between the position to which the ball, hit by the batters, has been hit and home base on the graphics (58) of the diamond.

Next, for example, by clicking the input key (59) for “graph,” the positions and the types of pitches thrown to these two batters by the pitcher are simultaneously compared using a pie chart (63), or the like, so that an analysis can be gained telling the pitcher what types of combinations of pitches or what types of pitches to throw to a specific batter and, at the same time, the pitcher's own faults can be discovered and corrected while other analysis means, or effects, are almost the same as in the above described first analysis screen and it is, of course, possible to extract the two batters' images, as described above, so as to be represented as a still image, an intermittently moving image or a moving image.

### Third Embodiment of Analysis Screen

On the third analysis screen (64), shown in FIG. 13, by clicking the speed output key (71) provided in the output setting menu (C) of FIG. 6, the positions and the types of pitches, as well as the speed at that time, thrown by a certain pitcher to a specific batter can be extracted so as to be automatically represented (70) in letters or graphics with colors.

Thereby, the speed and the number of pitches thrown by a specific pitcher is analyzed and, as a result, the batter can, of course, gain information for correcting his form at the time of addressing this pitcher or at the time of making contact with the ball thrown by this pitcher.

### Fourth Embodiment of Analysis Screen

The fourth analysis screen (66) of FIG. 14 is gained by clicking the output key (72) for the match up provided in the above described output setting menu (C) and on this fourth analysis screen (66), the name of a specific batter (67) and a table (68) are represented wherein the names of all of the pitchers (69) who have faced this batter are represented along the direction of the Y axis of this table (68) and, at least, the number of at bats, the number of hits, the number of homeruns, the number of walks and times hit by the pitch, the number of strike outs, batting average and batting average with runners in scoring position (70) are represented along the direction of the X axis of the table.

Thereby, at the intersections between this Y axis and this X axis, the number of the items therein and the calculation results are displayed by counting or by calculating utilizing the data stored in the personal computer.

In addition, on the above described screen (66), a table of right-handed pitchers who have faced the batter and a table of left-handed pitchers who have faced the same batter can be provided and, as a result, it becomes possible find out if this pitcher performs poorly against left-handed batters or performs poorly against right-handed batters.

Here, when implementing the above described present invention, the player, themselves, or a coach or coordinator can freely draw letters or graphics on the images displayed on respective analysis screens (47), (55), (64) and (66) to be used for instruction and the images, after having been drawn, can again be viewed on the monitor via the server or by means of a DVD by using the data input terminal (12), such as the touch pen (11) of this system.

### Effect of the Invention

The effect of this invention is to automatically extract a variety of representations of analysis results, as data based on data gained from the actually played game, and display them on a stationary terminal, such as a personal computer, or on a mobile terminal, such as a cellular telephone, and to simultaneously reproduce the images of players on two screens of the display monitor, without overlapping, so as to let the players, a coach or an advisor to recognize the difference in the movements of two players by means of the moving images and, thereby, to be helpful for correction by the players, themselves, or for the instruction by the coach or the advisor.

In general, according to this invention, information desired to be known concerning the relationships between batters and pitchers can be gained by searching, processing or editing the past data, which have been inputted in advance, or by outputting images as necessary, so that pitchers and batters can come to recognize their own weak points and strong points so as to use this information for the improvement of their own skills. In addition, by strategically using this information gained according to the present invention, a large advantage can be gained over the opposing team the next time that the two teams meet.

### BRIEF DESCRIPTION OF THE DRAWINGS

FIG. 1 is a block description diagram of a scorecard preparation system of a device utilized in the embodiments of this invention;

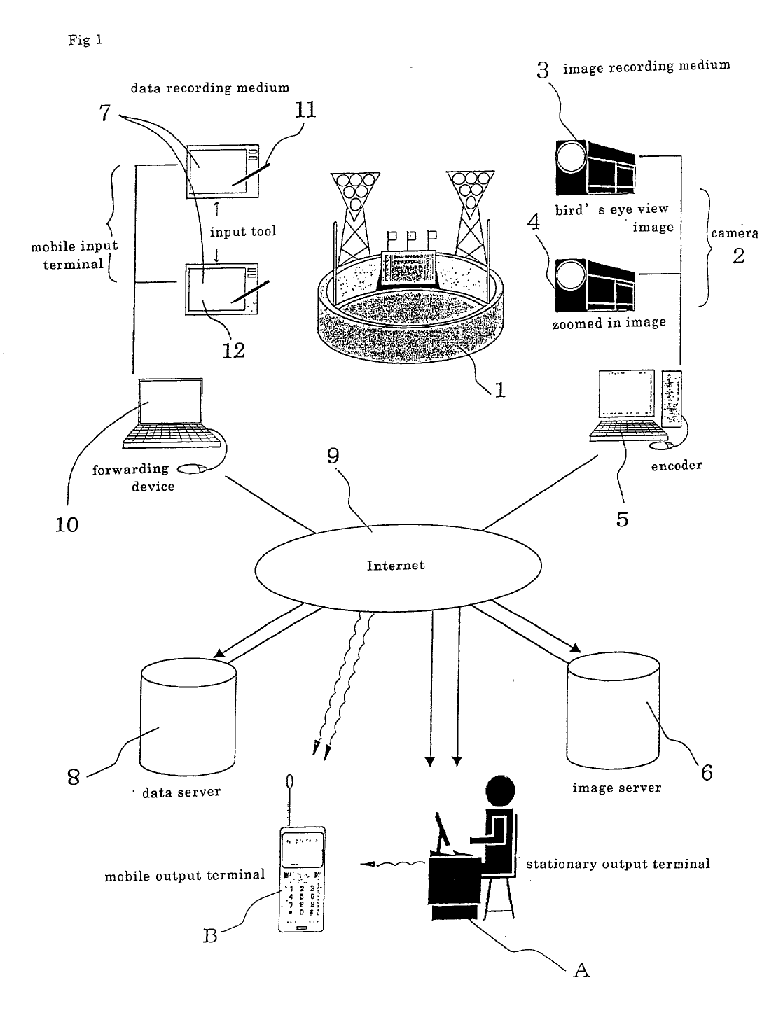

FIG. 2 is a description diagram of a screen displayed on the display of the device;

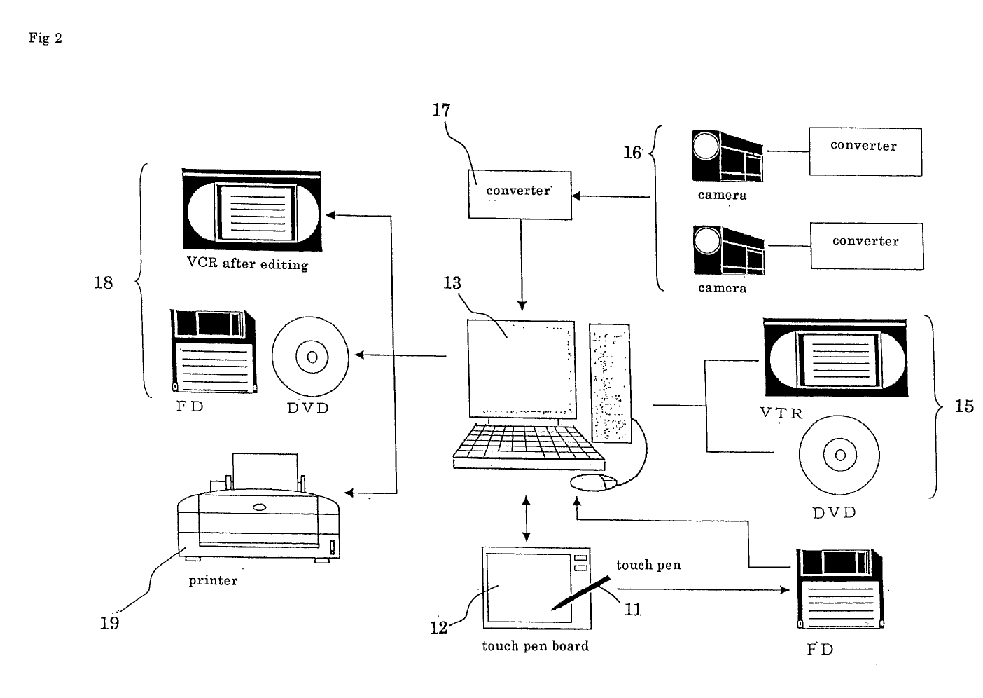

FIG. 3 is a description diagram 1 of an editing screen displayed in an automatic editing system;

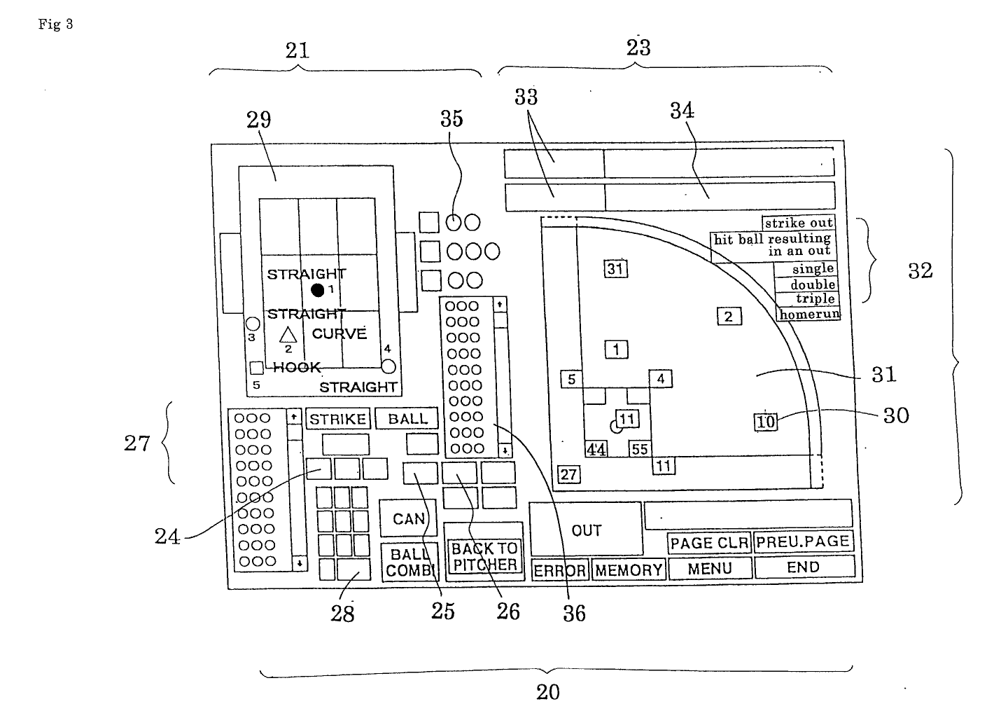

FIG. 4 is a description diagram 2 of an editing screen displayed in an automatic editing system;

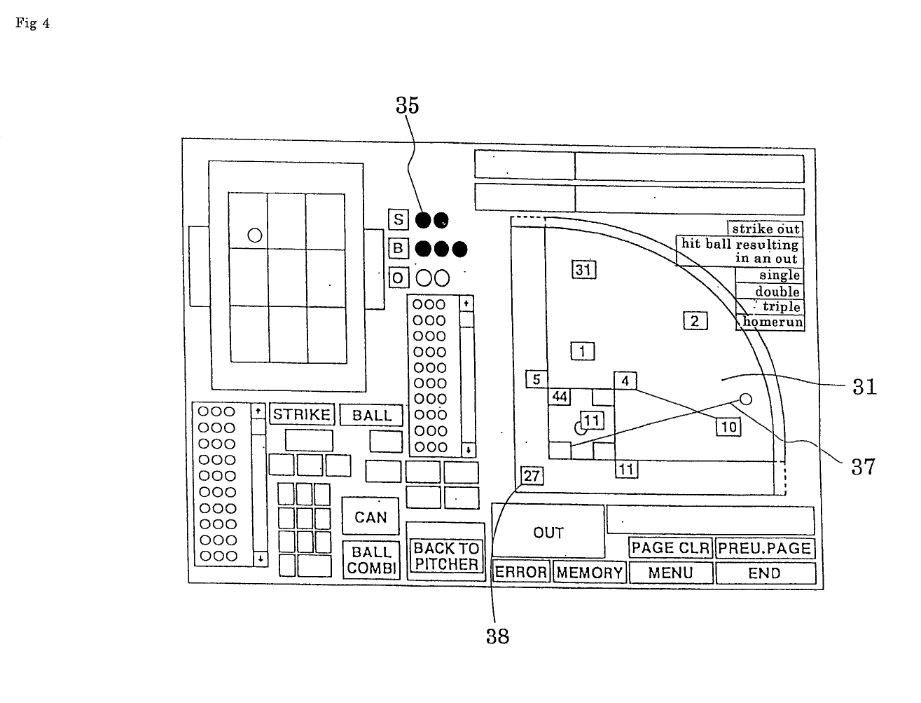

FIG. 5 is a description diagram 3 of an editing screen displayed in an automatic editing system;

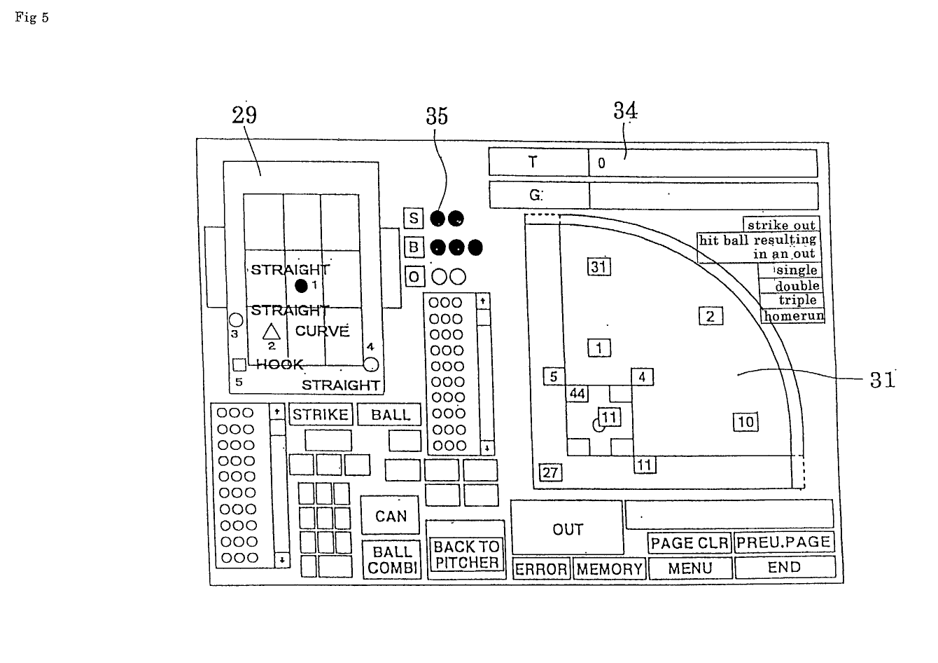

FIG. 6 is a description diagram of an output setting main menu;

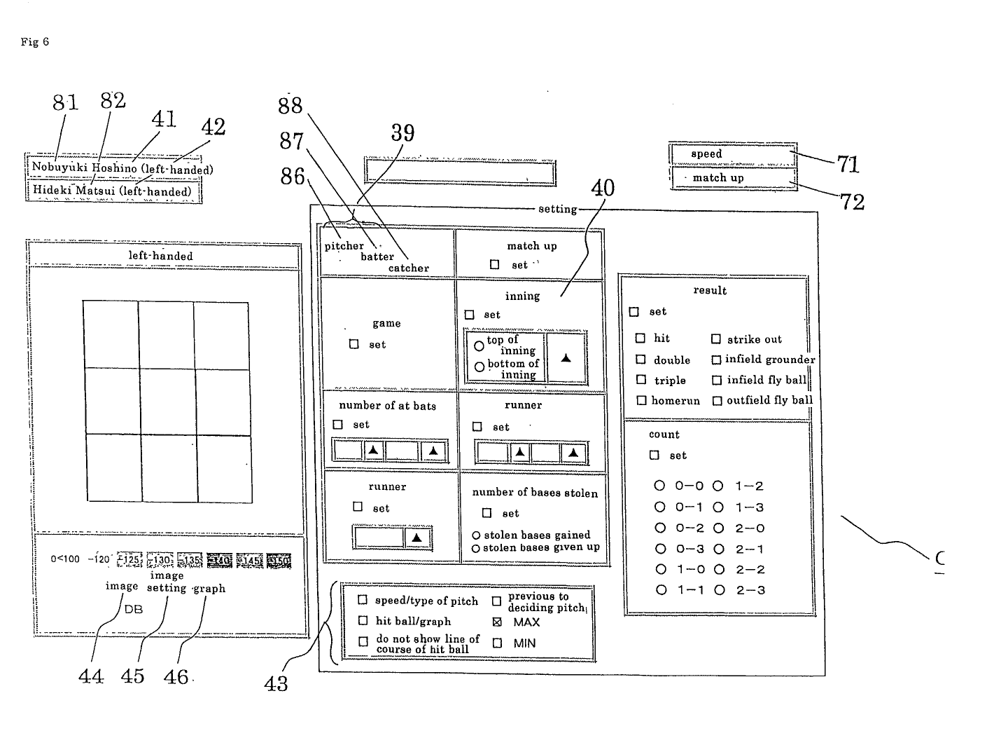

FIG. 7 is a description diagram of a motion analysis screen of the first embodiment;

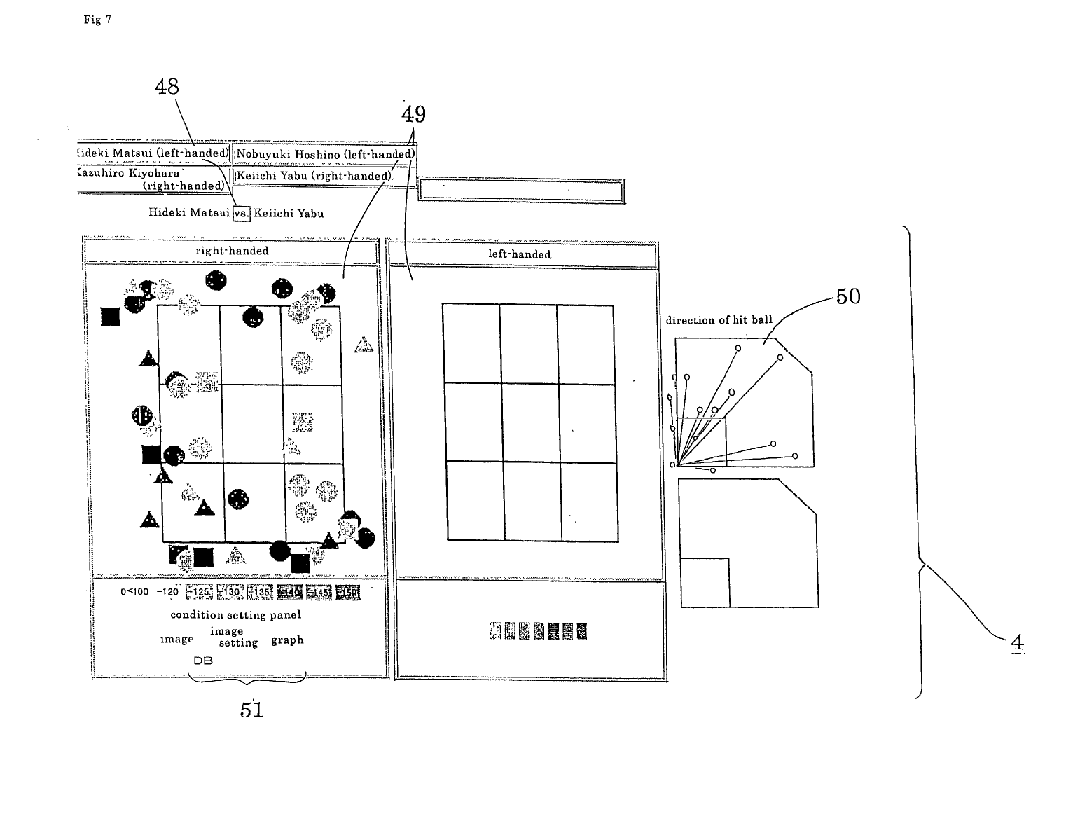

FIG. 8 is a description diagram 1 of the motion analysis screen of the first embodiment into which image screens are incorporated;

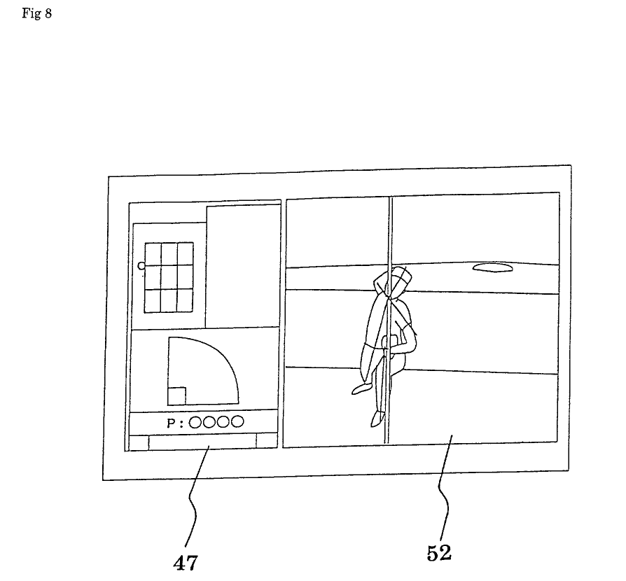

FIG. 9 is a description diagram 2 of the motion analysis screen of the first embodiment into which image screens are incorporated;

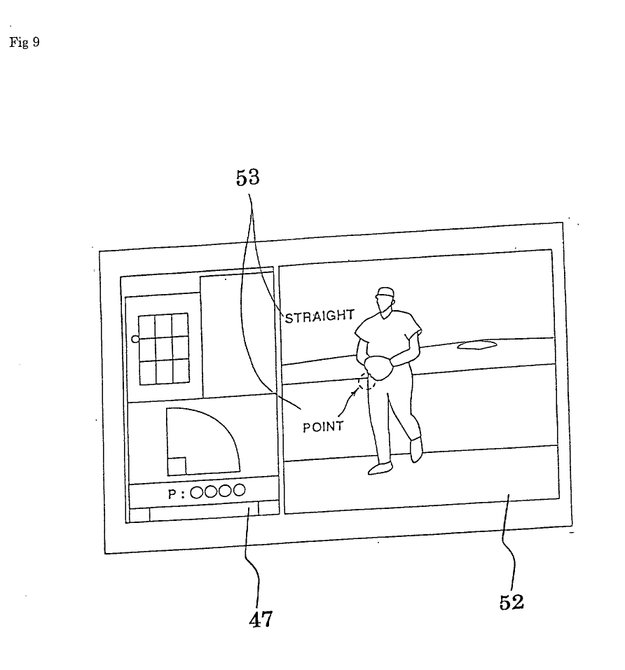

FIG. 10 is a description diagram 3 of the motion analysis screen of the first embodiment into which image screens are incorporated;

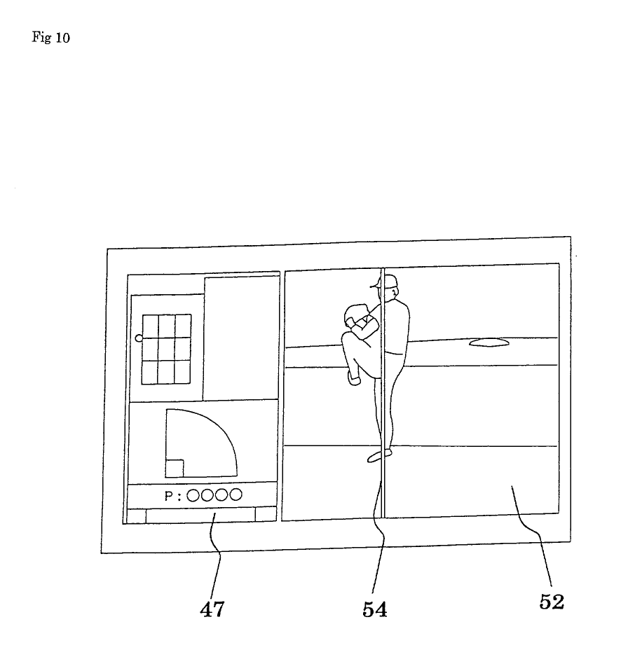

FIG. 11 is a description diagram of a motion analysis screen of the second embodiment;

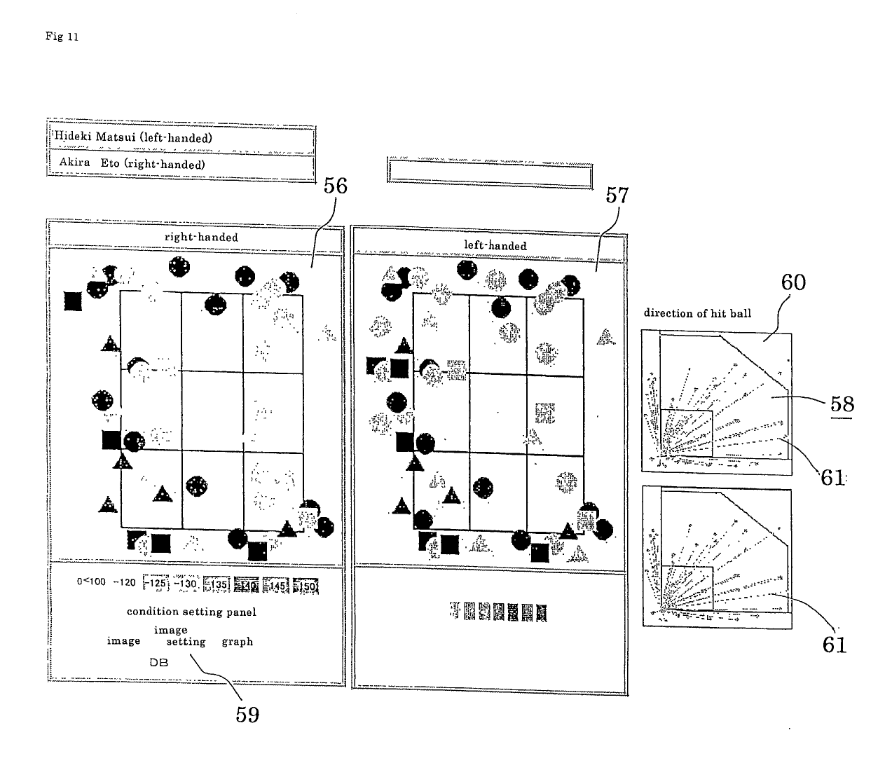

FIG. 12 is a description diagram of the motion analysis screen of the second embodiment into which image screens are incorporated;

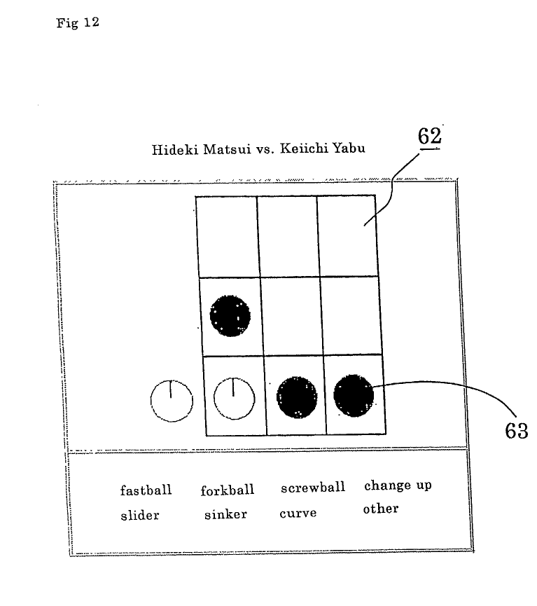

FIG. 13 is a description diagram of a motion analysis screen of the third embodiment; and

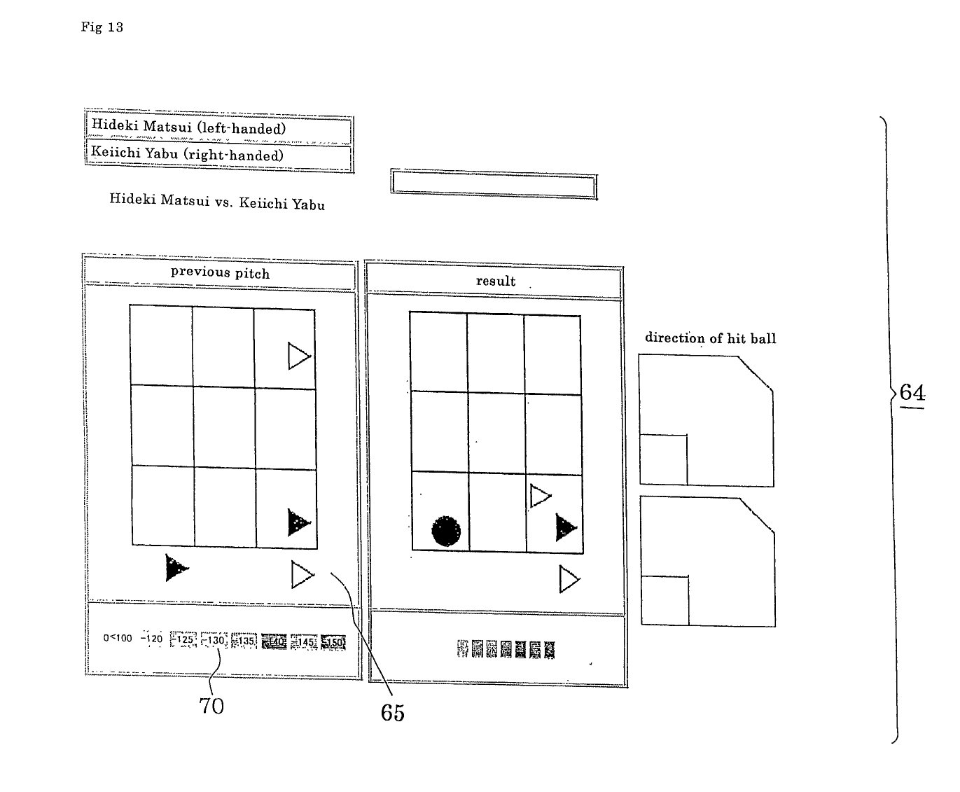

FIG. 14 is a description diagram of a motion analysis screen of the fourth embodiment.

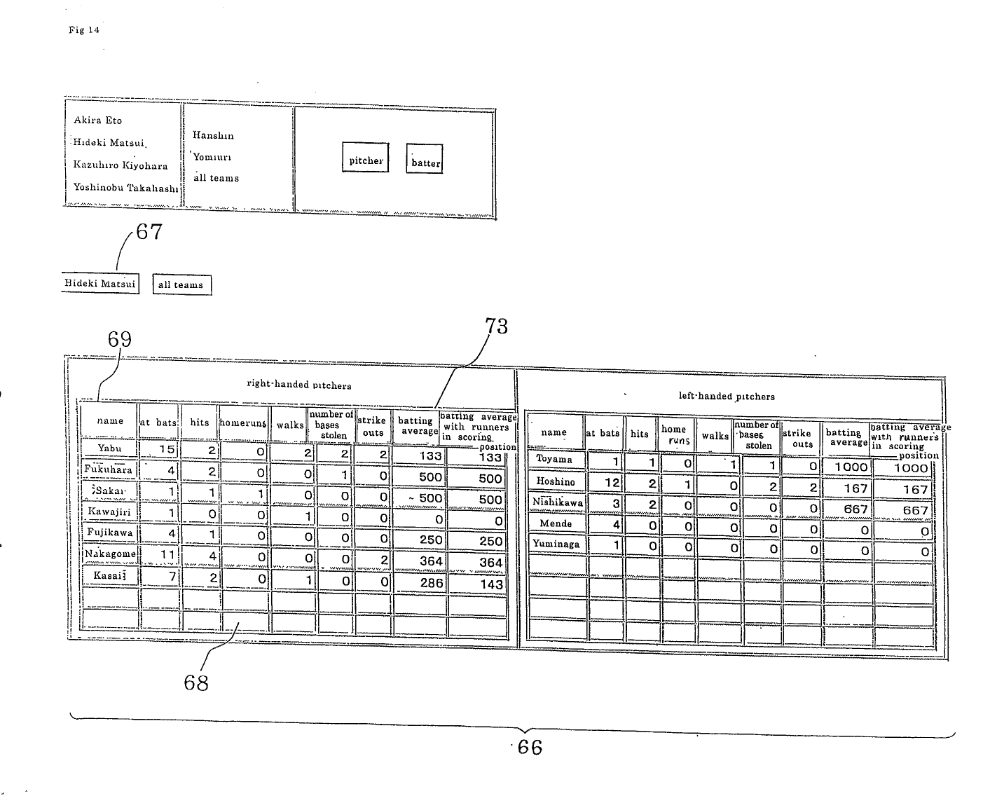

[Explanation of the Numerals]

| A | stationary output terminal device |
|---|---|
| B | mobile output terminal |
| C | output setting main menu |
| 1 | baseball stadium |
| 2 | plurality of cameras |
| 3 | bird's eye view image |
| 4 | zoomed in wide image |
| 5 | encoder |
| 6 | image server |
| 7 | input terminal |
| 8 | data server |
| 9 | Internet line |
| 10 | data forwarding device |
| 11 | touch pen |
| 12 | input terminal |
| 13 | personal computer |
| 15 | video tape or DVD |
| 16 | video camera of a digital system or digital camera |
| 17 | converter |
| 18 | VCR, writable DVD or FD |
| 19 | printer |
| 20 | input screen |
| 21 | input part for pitcher motion |
| 22 | input part for batters and fielders |
| 23 | other information part |
| 24 | input key for starting time and finishing time of game |
| 25 | pitcher name |
| 26 | input key for name of batter facing pitcher |
| 27 | input key for pitch type |
| 28 | input key for numerals from 0 to 9 |
| 29 | graphics of strike zone |
| 30 | names or numbers of all of the fielders and batter |
| 31 | graphics of diamond |
| 32 | input keys for strike out, hit ball resulting in an out, single, double, |
| | triple and homerun |
| 33 | name representations of respective opposing teams |
| 34 | graphics of scoreboard |
| 35 | input keys for ball, strike and out count |
| 36 | letters or graphics |
| 37 | line |
| 38 | representation |
| 39 | input keys |
| 40 | input keys for innings, top of inning and bottom of inning |
| 41 | pitcher name |
| 42 | name of batter facing pitcher |
| 43 | input key for pitch type |
| 44 | image display |
| 45 | graph representation |
| 46 | table representation |
| 47 | first analysis screen |
| 48 | display screen of a match up between a pitcher and a batter |
| 49 | graphics of strike zone |
| 50 | graphics of diamond |
| 51 | input keys for image display, graph representation and table |
| | representation |
| 52 | representation |
| 53 | letter representation |
| 54 | “vertical line” |
| 55 | second analysis screen |
| 56 | graphics of strike zone |
| 57 | graphics of strike zone |
| 58 | graphics of diamond |
| 59 | input keys for image display, graph representation and condition |
| | representation |
| 60 | letters or graphics |
| 61 | line |
| 62 | strike zone |
| 63 | pie chart |
| 64 | third analysis screen |
| 65 | representation |
| 66 | fourth analysis screen |
| 67 | specific batter name |
| 68 | table |
| 69 | pitcher name |
| 70 | representation |
| 71 | speed output key |
| 72 | output key of a match up between a pitcher and a batter |
| 73 | representation |
| 81 | “Nobuyuki Hoshino” |
| 82 | “Hideki Matsui” |
| 85 | condition setting screen |
| 86 | pitcher |
| 87 | batter |
| 88 | catcher |

What is claimed is:

1. A method for information processing comprising a scorecard preparation system, an automatic editing system and a motion analysis system of a baseball game characterized by comprising:
a data recording medium, such as a tape, an FD or a data server which contain real time data that are forwarded by utilizing a network, comprising a scorecard preparation system, a video system, an automatic editing system, a motion analysis system and the step of forwarding the data, wherein the body of the scorecard preparation system has an input terminal, such as a mobile terminal, and wherein the movements of the players and other information are inputted by means of the input terminal in a chronological manner;
an image recording medium such as a VCR, a DVD or an image server which contain a plural number of pieces of image information, such as bird's eye view images or zoomed in images of said players, the step of encoding and forwarding them and said digitalized video data transmitted through the usage of a network;
the screen of said data input terminal, wherein the user (audience) accesses either of said data medium or image medium, or both of them, over the network and links together a predetermined image and data so as to be outputted on the same screen of the output terminal of a mobile body, such as a cellular telephone, a personal computer, or the like, comprises an input part for pitcher motion, an input part for batter motion and an other information part;
in the input part for pitcher motion, at least, input keys for the starting time and finishing time of the game, input keys for names of the pitchers and names of the batters facing the respective pitchers of the game, input keys for pitch types thrown by the pitcher, such as curve, screwball or slider, input keys for numerals from 0 to 9 and graphics of the strike zone are arranged in appropriate locations;
in the input part for batter motion, at least, graphics of the diamond showing the names or numbers of all of the fielders and the batter in predetermined locations and input keys for strike out, hit ball resulting in an out, single, double, triple, homerun are arranged in proper positions;
in the other information parts, at least, a display of respective team names, a display of graphics of the scoreboard and a display of the ball, strike and out count are arranged in proper positions;
at the time same time that the game starts, said input key for the starting time is clicked so that image information is inputted while the system is being driven in sync, then the pitch type thrown by the pitcher is determined so that the input key for pitch type of said input part for pitcher motion is clicked and by clicking positions on said graphics of the strike zone which agree with the positions of said pitches the types and the positions of the pitches are displayed on the graphics of the strike zone in the form of letters or graphics;
in the case that a batter gets a hit, the position to which the ball goes is defined on said graphics of the diamond and, by clicking the position on the graphics of the diamond, a line is automatically drawn between that position and home base; and
a scorecard preparation system wherein data of the desired inning number and of the entire game can be stored in the personal computer and the video tape or DVD for later viewing on the monitor.

2. A method for information processing comprising a scorecard preparation system, an automatic editing system and a motion analysis system of a baseball game according to claim 1, characterized in that:
input keys for ball and strike of the pitches thrown by the pitcher are provided in appropriate locations on the input screen;
the type of pitch thrown by the pitcher is determined so that the input key for the pitch type of said input part for pitcher motion is clicked and the positions on said graphics of the strike zone which agree with the positions of the pitch thrown by the pitcher are clicked and, thereby, the type and the location of the pitch are represented on the graphics of the strike zone in the form of letters or graphics;
at the same time, by clicking the input keys for ball or strike, the ball and strike count is automatically carried out so as to be displayed on the display for said count of balls, strikes, and outs.

3. A method for information processing comprising a scorecard preparation system, an automatic editing system and a motion analysis system of a baseball game according to claims 1 or 2, characterized in that when three outs are made “O” is automatically displayed in predetermined locations of said graphics of the scoreboard and, by clicking input keys for single, double, triple or homerun, the name or number of the batter is displayed close to the base in a predetermined position of the graphics of the diamond and whenever a runner reaches home base the cumulative score is displayed in a predetermined location of said graphics of the scoreboard.

4. A method for information processing comprising a scorecard preparation system, an automatic editing system and a motion analysis system of a baseball game according to one of claims 1 to 3, characterized in that:
said scorecard preparation system, a personal computer for processing, storing and controlling the inputted data, an input terminal, such as a touch pen for inputting information or conditions into this personal computer, and a monitor display;
one, or a plurality of, video or DVD recorders for connecting signals from the above personal computer to a personal computer via a converter for image processing, one, or a plurality of, controllers for displaying desired images on said monitor display as a still image or as a dynamic image incorporated in said video or DVD recorders, an automatic image editing system which is connected to the personal computer and which comprises a video or DVD cassette edited by said controller;
an editing screen outputted to the personal computer of this system, a personal computer which has a monitor display and which processes the inputted data, a converter connected to the personal computer, a motion analysis system comprising a video or a DVD deck for reproduction connected to said converter with a dedicated cable and a video or a DVD deck for recording, which is connected to said converter with a rank cable, and a screen for setting conditions outputted to the personal computer of this motion analysis system;
in the editing screen, at least, input keys for the names and numbers of the players who play in the game, or of all of the players, input keys for the names or numbers of the batters who play in the game, or of all of the batters, input keys for types of pitches thrown by the pitcher, such as curve, screwball or slider, input keys for time adjustment of the image output are arranged in appropriate locations;
as for the condition setting screen, input keys for selecting a pitcher, a batter or others for whom the conditions are set, input keys for selecting whether or not innings are set or for the inning number, top of the inning or bottom of the inning, input keys for pitcher name and name of the batter facing the pitcher in the game, input keys for types of pitches thrown by the pitcher, such as curve, screwball or slider, and input keys for image display, graph representation and table representation are arranged in appropriate locations.

5. A method for information processing comprising a scorecard preparation system, an automatic editing system and a motion analysis system of a baseball game, characterized by comprising:
a scorecard preparation system according to one of claims 1 to 4 and an editing screen of a personal computer according to claim 4; and
a first analysis screen displayed on the personal computer by selecting an input key for the match up between a particular pitcher and a particular batter on said condition setting screen, wherein
on the first analysis screen, at least, a display screen of the batter and the pitcher, graphics of the strike zone, graphics of the diamond, input keys for image display, graph representation and condition representation are arranged in appropriate locations, the positions and the types of pitches thrown by the pitcher at the time of the match up between the players are extracted from the data stored in the personal computer and are automatically displayed in the form of letters or graphics on the graphics of the strike zone and a line is automatically drawn between the position to which the ball, hit by the batter, goes and home base on the graphics of the diamond.

6. A method for information processing comprising a scorecard preparation system, an automatic editing system and a motion analysis system of a baseball game according to claim 5, characterized in that the image display part of the input keys for image display, graph representation and table representation is clicked so that an image at the time of the match up between the players is extracted from the video or DVD deck for reproduction, which is in sync with the personal computer, and can be displayed on a part of, or on the entirety of, said first analysis screen as a still image, an intermittently moving image or a moving image.

7. A method for information processing comprising a scorecard preparation system, an automatic editing system and a motion analysis system of a baseball game characterized by comprising a scorecard preparation system according to one of claims 1 to 6, an editing screen of a personal computer according to claim 4, a condition setting screen and a second analysis screen displayed on the personal computer by clicking the input key when two particular batters are selected on said condition setting screen, wherein, at least, graphics of the strike zones of the two batters, graphics of the diamond and the input keys for image display, graph representation and condition representation are arranged in appropriate locations on the second analysis screen and wherein the positions and the types of pitches thrown by the pitcher to the batters are extracted from the data stored in the personal computer so as to be automatically displayed in the form of letters or graphics on the graphics of the strike zones and lines are automatically drawn, on the graphics of the diamond, between the positions to which the balls, hit by the batters, go and the respective home bases.

8. A method for information processing comprising a scorecard preparation system, an automatic editing system and a motion analysis system of a baseball game according to claim 7, characterized in that the image display part of the input keys for condition representation is clicked so that an image at the time of the match up between the players is extracted from a video tape or DVD, which is in sync with the personal computer, so as to be displayed on a part of, or on the entirety of, said first analysis screen as a still image, an intermittently moving image or a moving image.

9. A method for information processing comprising a scorecard preparation system, an automatic editing system and a motion analysis system of a baseball game, characterized by comprising a scorecard preparation system according to one of claims 1 to 8, an editing screen of the personal computer, a motion analysis system, a third analysis screen displayed on the personal computer by clicking input keys for the match up between a particular pitcher and a particular batter of the motion analysis system and by clicking the graph representation key of the input keys for condition representation, wherein
on the third analysis screen, at least, the graphics of the strike zone, numerals for twelve combinations of pitches, including balls and strikes, graphics of a pie chart or a bar graph and input keys for image representation are arranged in appropriate locations;
the positions and the types of pitches thrown by the pitcher to a particular batter are extracted from the data stored in the personal computer and are automatically displayed in the form of letters or graphics on the graphics of the strike zone and graphics with colors, such as a pie chart or a bar graph, representing the ratio of the pitch type, at the time of each pitch, are automatically drawn in the vicinity of a variety numerals for ball and strike count.

10. A method for information processing comprising a scorecard preparation system, an automatic editing system and a motion analysis system of a baseball game according to claim 9, characterized in that by clicking the image display part of the input keys for condition display, images of the match up of the players are extracted from the video tape or DVD, which is in sync with the personal computer, so as to be displayed as a still image, an intermittently moving image or a moving image on a part of, or on the entirety of, said first analysis screen.

11. A method for information processing comprising a scorecard preparation system, an automatic editing system and a motion analysis system of a baseball game characterized by comprising a fourth analysis screen displayed on the personal computer by providing the input screen of a personal computer according to claims 1 to 10 with an input key for the pitch speed, of the pitch thrown by the pitcher of the game, and by clicking a speed output key which is provided on the condition setting screen, wherein
on this fourth analysis screen, at least, graphics of the strike zone and input keys for image display are arranged in appropriate locations and
the positions and the types as well as the speeds, of pitches thrown by a pitcher to a particular batter are extracted from the data stored in the personal computer so as to be automatically displayed on the graphics of the strike zone in the form of letters or graphics, or with colors.

12. A method for information processing comprising a scorecard preparation system, an automatic editing system and a motion analysis system of a baseball game according to claim 11, characterized in that the images of the match up between the players are extracted from the video tape or DVD, which is in sync with the personal computer, by means of the input key for image display so as to be displayed on a part of, or on the entirety of, said first analysis screen as a still image, an intermittently moving image or a moving image.

13. A method for information processing comprising a scorecard preparation system, an automatic editing system and a motion analysis system of a baseball game according to claims 6, 8, 10 or 12 characterized in that letters or graphics are freely drawn with an input terminal, such as a touch pen of this system, on the image displayed on each analysis screen and the images resulting from the drawing can be stored on the tape for later viewing on the monitor.

14. A method for information processing comprising a scorecard preparation system, an automatic editing system and a motion analysis system of a baseball game, characterized by having a fifth screen gained by clicking an output key for the match up which is provided on the condition setting screen according to claims 4 to 16, wherein this fifth screen displays the name of a particular batter, a table, wherein the names of all of the pitchers who have faced this batter are displayed along the direction of the Y axis of said table, at bats, hits, homeruns, walks and the number of times hit by the pitch, strike outs, batting average and batting average with runners in scoring position are displayed along the direction of the X axis of said table, and the number and the calculation results in respective items gained by counting based on the data stored in the personal computer are displayed at the intersection parts between said X axis and said Y axis.

15. A method for information processing comprising a scorecard preparation system, an automatic editing system and a motion analysis system of a baseball game according to claim 14, characterized in that said fifth analysis screen displays, at least, the name of a particular batter, a table concerning right-handed pitchers who have faced the batter, a table concerning left-handed pitchers who have faced the batter wherein the names of all of the pitchers who have faced this batter are displayed along the directions of Y axes of the respective tables, at bats, hits, homeruns, walks and the number of times hit by the pitch, strike outs, batting average and batting average with runners in scoring position are displayed along the directions of the X axes of the respective tables, and the number of items and the calculation results gained by counting based on the data stored in the personal computer are displayed at the intersection parts between the Y axis and the X axis.

16. A method for information processing comprising a scorecard preparation system, an automatic editing system and a motion analysis system of a baseball game, characterized by comprising a scorecard preparation system according to claims 1 to 15, an automatic editing system and a motion analysis system.
